(19) United States
(12) Patent Application Publication
(10) Pub. No.: US 2008/0163114 A1
(43) Pub. Date: Jul. 3, 2008

(54) IMAGE PROCESSING APPARATUS, IMAGE DISPLAY CONTROL APPARATUS AND CONTROL METHOD THEREOF

(75) Inventors: Jin-wook CHOI, Suwon-si (KR); Joung-hum BAEK, Hwaseong-si (KR); Cheon-yong CHO, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/860,826

(22) Filed: Sep. 25, 2007

(30) Foreign Application Priority Data
Jan. 3, 2007 (KR) 10-2007-0000663

(51) Int. Cl. G06F 3/048

(52) U.S. Cl. 715/810

(57) ABSTRACT

An image processing apparatus, includes: a menu generating part which generates and outputs a plurality of menu items which include at least one activated menu item; a user inputting part which receives instruction of a user to select one of the plurality of menu items; and a control part which controls the menu generating part so that, if an inactivated menu item is selected from the user inputting part, at least one of the activated menu item and the selected menu item is animated for a predetermined time and the selected menu item is activated after the predetermined time elapses.

### CROSS-REFERENCE TO RELATED APPLICATIONS

This application claims priority from Korean Patent Application No. 10-2007-0000663, filed on Jan. 3, 2007 in the Korean Intellectual Property Office, the disclosure of which is incorporated herein by reference.

### BACKGROUND OF INVENTION

1. Field of Invention

An image processing apparatus, an image display control apparatus and a control method thereof consistent with the present invention relate to continuously and dynamically changing a menu item on a screen so that a user can easily and comfortably use the menu.

2. Description of the Related Art

In general, a display performance of a display apparatus varies according to the display apparatus' graphics card, the illumination state of the display apparatus and other environmental conditions. To maintain a display of optimum image quality, it is necessary to adjust the display performance for the particular setting of the display apparatus in use.

In general, an image processing apparatus as a display apparatus, or an image display control apparatus controlling a screen setting state of the display apparatus displays a plurality of adjusting menu items, which adjust a screen brightness or distinction and, therefore, the display performance. The image processing apparatus or the image display control apparatus typically uses a graphic user interface (GUI) screen to adjust the display performance.

However, if a user selects a new adjusting menu item by using a user inputting part, a graphic with respect to the selected adjusting menu item is instantaneously changed. Accordingly, there is not a smooth connection between a graphic of an adjusting menu item previously activated and a graphic of an adjusting menu item selected by the user to be activated, and the user feels that the connection is not natural. Also, in the image display control apparatus controlling a setting state of the display apparatus, it takes a long time to request a menu setting information to the display apparatus and receive the menu setting information from the display apparatus. Here, since the adjusting menu item maintains a static state until the menu setting information is received from the display apparatus, the user feels like he or she is blindly waiting.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, it is an aspect of the present invention to provide an image processing apparatus, an image display control apparatus and a control method thereof that enables a user to easily and comfortably use an adjusting menu item.

Another aspect of the present invention is to provide an image processing apparatus, an image display control apparatus and a control method thereof that continuously and dynamically changes a menu item on a screen unlike a conventional static change.

Additional aspects of the present invention will be set forth in part in the description which follows and, in part, will be obvious from the description, or may be learned by practice of the present invention.

The foregoing and/or other aspects of the present invention can be achieved by providing an image processing apparatus, comprising: a menu generating part which generates and outputs a plurality of menu items which comprise at least one activated menu item; a user inputting part which receives instruction of a user for change of the menu item; and a control part which controls the menu generating part, if an inactivated menu item is selected from the user inputting part, to animate at least one of the activated menu item and the selected menu item for a predetermined time, and to activate the selected menu item after the predetermined time elapses.

According to an aspect of the invention, the menu items comprise a plurality of tab menus which display a high level menu item, and a plurality of adjusting menus which display a low level menu item.

According to an aspect of the invention, if an inactivated tab menu is selected from the user inputting part, the control part controls the menu generating part to process an image of the activated tab menu to be gradually vaguer, and to process an image of the selected tab menu to be gradually stronger.

According to an aspect of the invention, if an inactivated tab menu is selected from the user inputting part, the control part controls the menu generating part to gradually disappear text of an adjusting menu with respect to the activated tab menu.

According to an aspect of the invention, if an inactivated adjusting menu is selected from the user inputting part, the control part controls the menu generating part to gradually reduce the size of text of the activated adjusting menu, and to gradually enlarge the size of text of the selected adjusting menu.

According to an aspect of the invention, if an inactivated adjusting menu is selected from the user inputting part, the control part controls the menu generating part to gradually change the color of text of the activated adjusting menu into an inactivation mode, and to gradually change the color of text of the selected adjusting menu into an activation mode.

According to an aspect of the invention, the menu items further comprise a sub menu with respect to the adjusting menu, and if an inactivated adjusting menu is selected from the user inputting part, the control part controls the menu generating part to generate a sub menu with respect to the selected adjusting menu after the animation of the activated adjusting menu and the selected adjusting menu is ended.

According to an aspect of the invention, the menu items further comprise a plurality of sub menus with respect to the adjusting menus, and if an inactivated sub menu is selected from the user inputting part, the control part controls the menu generating part to gradually change the activated sub menu into an inactivation mode, and to gradually change the selected sub menu into an activation mode.

The foregoing and/or other aspects of the present invention can be achieved by providing an image display control apparatus which controls a setting state of a display apparatus, the image display control apparatus comprising: a menu generating part which generates and outputs a user interface (UI) screen which comprises a plurality of menu items which comprise at least one activated menu item; an image transmitting part which transmits the UI screen to the display apparatus; a communicating module part which transmits and receives a menu setting information of the display apparatus; and a control part which controls communicating, if an inactivated menu item is selected, the communicating module part to request a menu setting information with respect to the selected menu item to the display apparatus, and the menu generating part to animate at least one of the activated menu item and the selected menu item for a predetermined time.

According to an aspect of the invention, the image display control apparatus further comprises a user inputting part which receives instruction of a user for change of the menu item, wherein, if an inactivated menu item is selected from the user inputting part, the control part controls the communicating module part to request a menu setting information with respect to the selected menu item to the display apparatus.

According to an aspect of the invention, the menu items comprise a plurality of tab menus which display a high level menu item, and a plurality of adjusting menus which display a low level menu item.

According to an aspect of the invention, if an inactivated tab menu is selected from the user inputting part, the control part controls the menu generating part to process an image of the activated tab menu to be gradually vaguer, and to process an image of the selected tab menu to be gradually stronger.

According to an aspect of the invention, if an inactivated adjusting menu is selected from the user inputting part, the control part controls the menu generating part to gradually reduce the size of text of the activated adjusting menu, and to gradually enlarge the size of text of the selected adjusting menu.

According to an aspect of the invention, if an inactivated adjusting menu is selected from the user inputting part, the control part controls the menu generating part to gradually change the color of text of the activated adjusting menu into an inactivation mode, and to gradually change the color of text of the selected adjusting menu into an activation mode.

According to an aspect of the invention, the menu items further comprise a sub menu with respect to the adjusting menus, and if a corresponding menu setting information is received through the communicating module part, the control part controls the menu generating part to generate the received menu setting information as a sub menu with respect to the selected adjusting menu.

According to an aspect of the invention, if a confirming order is inputted from the user inputting part, the control part controls the communicating module part to transmit a menu setting information displayed in the sub menu to the display apparatus.

According to an aspect of the invention, if a first UI screen displayed in a first display apparatus is moved to a second display apparatus through the user inputting part, the control part controls the menu generating part to make the first UI screen be gradually vaguer, and to gradually activate a second UI screen which comprises a plurality of menu items appropriate for the second display apparatus.

According to an aspect of the invention, if the first UI screen displayed in the first display apparatus is moved to the second display apparatus through the user inputting part, the control part controls the communicating module part to request a menu setting information with respect to the activated adjusting menu to the second display apparatus.

According to an aspect of the invention, if a corresponding menu setting information is received from the second display apparatus through the communicating module part, the control part controls the menu generating part to display the received menu setting information as a sub menu with respect to the activated adjusting menu.

The foregoing and/or other aspects of the present invention can be achieved by providing a control method of an image processing apparatus which comprises a menu generating part which generates and outputs a plurality of menu items which comprise at least one activated menu item, the control method comprising: receiving instruction of a user for change of the menu item; animating at least one of the activated menu item and an inactivated selected menu item for a predetermined time if the inactivated menu item is selected; and activating the selected menu item if the predetermined time elapses.

According to an aspect of the invention, the menu items comprise a plurality of tab menus which display a high level menu item, and if an inactivated tab menu is selected, the animating comprises processing an image of the activated tab menu to be gradually vaguer, and processing an image of the selected tab menu to be gradually stronger.

According to an aspect of the invention, the menu items comprise a plurality of adjusting menus which display a low level menu item, and if an inactivated adjusting menu is selected, the animating comprises gradually reducing the size of text of the activated adjusting menu, and gradually enlarging the size of text of the selected adjusting menu.

According to an aspect of the invention, the menu items comprise a plurality of adjusting menus which display a low level menu item, and if an inactivated adjusting menu is selected, the animating comprises gradually changing the color of text of the activated adjusting menu into an inactivation mode, and gradually changing the color of text of the selected adjusting menu into an activation mode.

According to an aspect of the invention, the menu items comprise a plurality of sub menus with respect to the adjusting menu, and if an inactivated sub menu is selected, the animating comprises gradually changing the activated sub menu into an inactivation mode, and gradually changing the selected sub menu into an activation mode.

The foregoing and/or other aspects of the present invention can be achieved by providing a control method of an image display control apparatus which controls a setting state of a display apparatus, and comprises a menu generating part which generates and outputs a user interface (UI) screen which comprises a plurality of menu items which comprise at least one activated menu item, the control method comprising: receiving instruction of a user for change of the menu item; requesting a menu setting information with respect to a selected inactivated menu item to the display apparatus if the inactivated menu item is selected; animating at least one of the activated menu item and the selected menu item for a predetermined time; and transmitting a user interface (UI) screen which comprises the animated menu item to the display apparatus.

According to an aspect of the invention, the control method of the image display control apparatus further comprises activating the selected menu item if a corresponding menu setting information is received, and displaying the received menu setting information.

According to an aspect of the invention, the control method of the image display control apparatus further comprises transmitting a changed menu setting information to the display apparatus if a confirming order is inputted.

According to an aspect of the invention, the control method of the image display control apparatus further comprises requesting a menu setting information with respect to the activated adjusting menu to a second display apparatus if a first UI screen displayed in a first display apparatus is moved to the second display apparatus.

According to an aspect of the invention, the control method of the image display control apparatus further comprises making the first UI screen be gradually vaguer, and gradually activating a second UI screen which comprises a plurality of menu items appropriate for the second display apparatus if the first UI screen displayed in the first display apparatus is moved to the second display apparatus.

According to an aspect of the invention, the control method of the image display control apparatus further comprises displaying a received corresponding menu setting information if the corresponding menu setting information is received from the second display apparatus.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and/or other aspects of the present invention will become apparent and more readily appreciated from the following description of the exemplary embodiments, taken in conjunction with the accompanying drawings, in which:

FIG. 1 is a block diagram illustrating a configuration of an image processing apparatus according to a first exemplary embodiment of the present invention;

FIG. 2 is a block diagram illustrating configurations of an image display control apparatus and a display apparatus according to a second exemplary embodiment of the present invention;

FIG. 3 is a flowchart illustrating a control method of an image processing apparatus according to a first exemplary embodiment of the present invention;

FIG. 4 is a flowchart illustrating a control method of an image display control apparatus according to a second exemplary embodiment of the present invention;

FIGS. 5A to 5C illustrate an example of changing of a tab menu according to an exemplary embodiment of the present invention;

FIGS. 6A to 6C illustrate an example of changing of an adjusting menu according to the exemplary embodiment of the present invention; and

FIGS. 7A to 7C illustrate an example of changing of a menu item between display apparatuses according to the exemplary embodiment of the present invention.

### DETAILED DESCRIPTION OF EXEMPLARY EMBODIMENTS OF THE INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

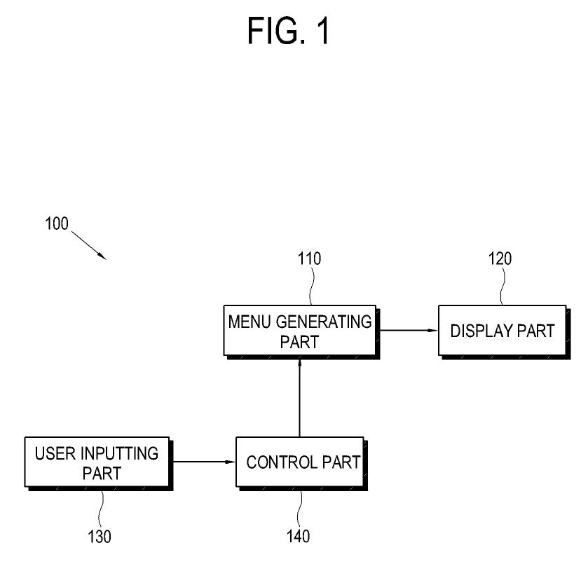

As shown in FIG. 1, an image processing apparatus 100 includes a menu generating part 110, a display part 120, a user inputting part 130 and a control part 140.

The menu generating part 110 generates and outputs a plurality of menu items including at least one activated menu item so that a display property of the image processing apparatus 100 is adjusted. That is, the menu generating part 110 generates and outputs a graphic user interface (GUI) screen including a plurality of menu items for adjusting a screen brightness, contrast or sharpness.

The display part 120 includes a liquid crystal display (LCD), a plasma display panel (PDP), a cathode ray tube (CRT) or the like, and displays the GUI screen generated by the menu generating part 110.

The user inputting part 130 receives instruction of a user about changing of a menu item. The user inputting part 130 includes a button or a touch panel of the image processing apparatus 100, a keyboard and a mouse connected by wire, a wireless remote controller, etc.

The control part 140 performs a total control of the image processing apparatus 100, and includes a screen setting program. Accordingly, the control part 140 controls the menu generating part 110 so that the screen setting program is driven based on an instruction of a user to change a menu item of the GUI screen. That is, if an inactivated menu item of the GUI screen is selected from the use inputting part 130, the control part 140 controls the menu generating part 110 so that at least one of an activated menu item and the selected menu item is animated for a predetermined time, and the selected menu item is activated if the predetermined time elapses.

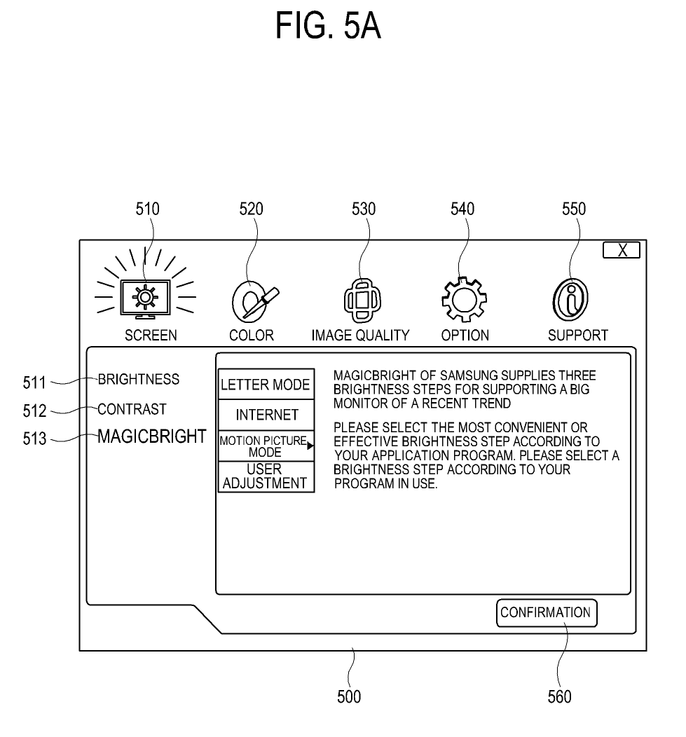

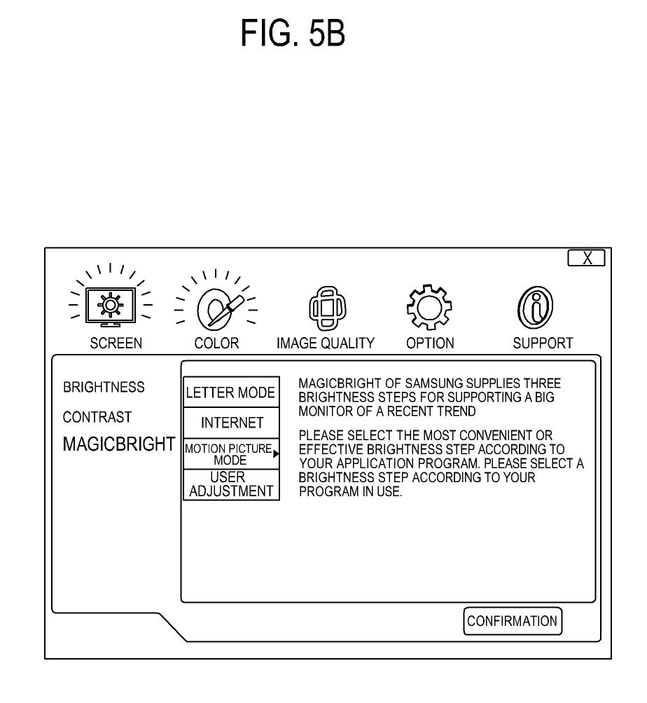

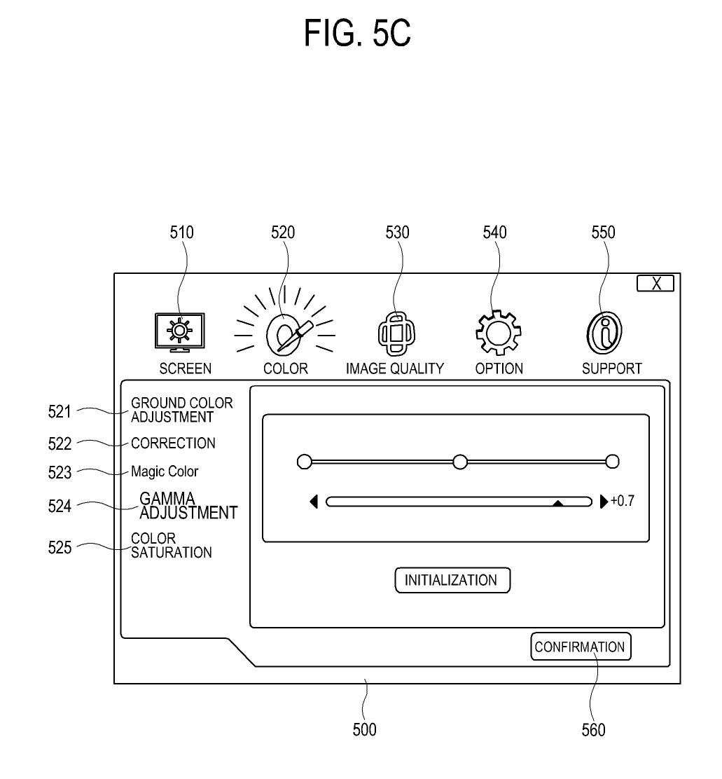

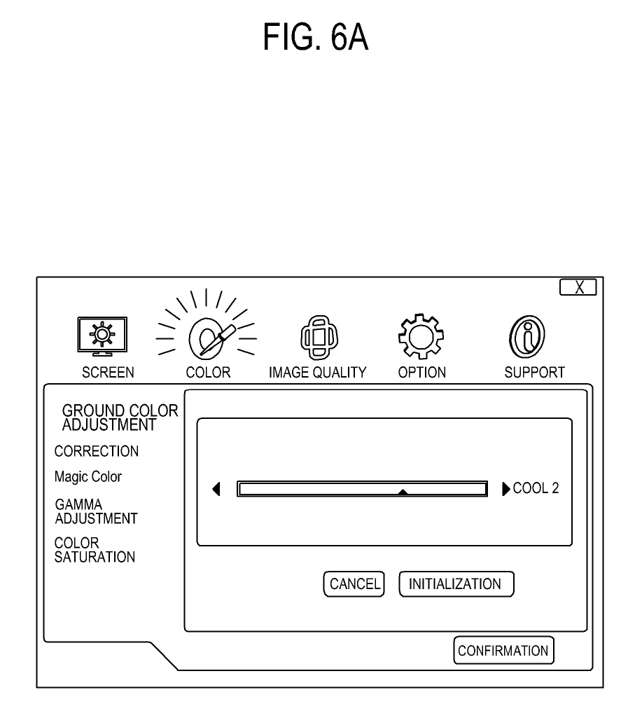

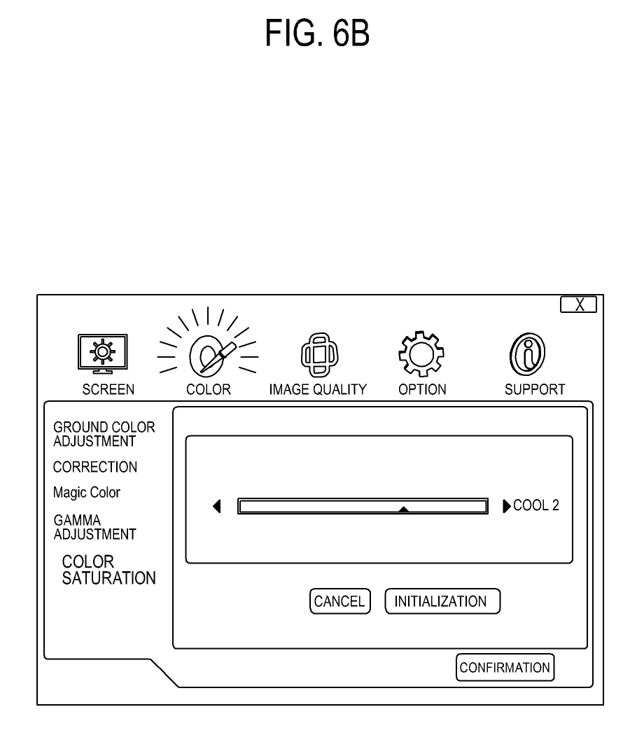

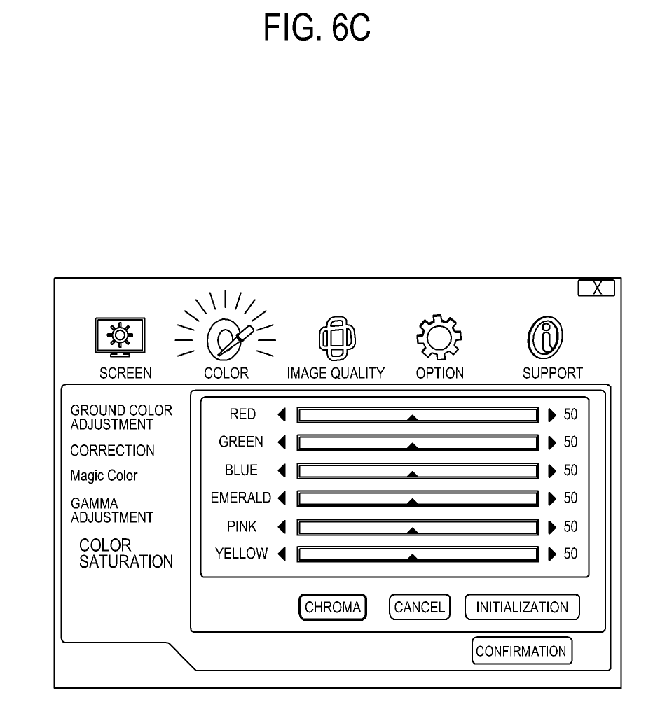

Hereinafter, a change of a menu item according to an exemplary embodiment of the present invention will be described. FIGS. 5A to 5C illustrate an example of changing of a tab menu according to an exemplary embodiment of the present invention, and FIGS. 6A to 6C illustrate an example of changing of an adjusting menu according to the exemplary embodiment of the present invention.

As shown in FIG. 5A, in a GUI screen 500 displayed by the menu generating part 110, tab menus including a screen tab 510, a color tab 520, an image quality tab 530, an option tab 540 and a support tab 550 are displayed as a high level menu item.

The screen tab 510 is a tab for adjusting a screen state wanted by a user. As a low level menu item of the screen tab 510, there are a brightness menu 511 adjusting overall screen to be bright or dark, a contrast menu 512 adjusting a brightness difference between a bright spot and a dark spot of a screen, and a magic bright menu 513 for providing a display screen appropriate for various user environments. For convenience, a menu corresponding to the brightness menu 511, the contrast menu 512 and the magic bright menu 513 is referred to ‘adjusting menu’.

Also, in the GUI screen 500, “letter mode”, “internet”, “motion picture mode” and “user adjustment” are displayed as a sub menu of the magic bright menu 513, and a confirming button 560 for storing a menu setting information displayed in the sub menu is displayed.

At first, an example of changing of a tab menu shown in FIGS. 5A to 5C will be described. As shown in FIG. 5A, the screen tab 510 is displayed as an activated tab menu (shown by indication of longer brightness lines) in the GUI screen 500 tab menu.

As shown in FIG. 5B, if a user selects the inactivated color tab 520 through the user inputting part 130, the menu generating part 110 displays the activated screen tab 510 so that it becomes gradually vaguer (i.e., less clear-shown by indication of shorter brightness lines), and displays the selected color tab 520 so that it becomes gradually stronger (shown by indication of shorter brightness lines) for a predetermined time. Also, the menu generating part 110 processes a text property so that the brightness menu 511, the contrast menu 512 and the magic bright 513 of the activated screen tab 510 can gradually disappear.

As shown in FIG. 5C, the menu generating part 110 finally activates and displays only the color tab 520 (shown by indication of longer brightness lines) in the GUI screen 500, and displays a background color adjusting menu 521, a correcting menu 522, a magic color menu 523, a gamma adjusting menu 524 and a color saturation menu 525 as an adjusting menu of the color tab 520. Also, the menu generating part 110 displays a menu setting information, that is, a gamma value set as a sub menu of the gamma adjusting menu 524.

FIGS. 6A to 6C illustrate an example of changing of an adjusting menu. As shown in FIG. 6A, the color tab 520 is displayed as an activated tab menu in the GUI screen 500, and the background color adjusting menu 521 among the low level menu items of the color tab 520 is activated.

As shown in FIG. 6B, if a user selects the inactivated color saturation menu 525 through the user inputting part 130, the menu generating part 110 gradually reduces the size of text of the activated background color adjusting menu 521, and gradually enlarges the size of text of the selected color saturation menu 525 for a predetermined time. Also, the menu generating part 110 gradually changes the color of text of the activated background color adjusting menu 521 into an inactivation mode, and gradually changes the color of text of the selected color saturation menu 525 into an activation mode for a predetermined time. Also, the menu generating part 110 gradually reduces the size of text of the activated background color adjusting menu 521 while moving the text rightward, and gradually enlarges the size of text of the selected color saturation menu 525 while moving the text leftward.

As shown in FIG. 6C, the menu generating part 110 finally activates and displays the color saturation menu 525 in the GUI screen 500. Also, the menu generating part 110 generates a menu setting information with respect to each color as a sub menu of the color saturation menu 525, and displays it in the display part 120.

Regarding a sub menu of the letter mode, the internet, the motion picture mode and the user adjustment with respect to the magic bright menu 513 shown in FIG. 5A, if a user selects an inactivated sub menu through the user inputting part 130, the menu generating part 110 may gradually process an activated sub menu as an inactivation mode, and may gradually process the selected sub menu as an activation mode.

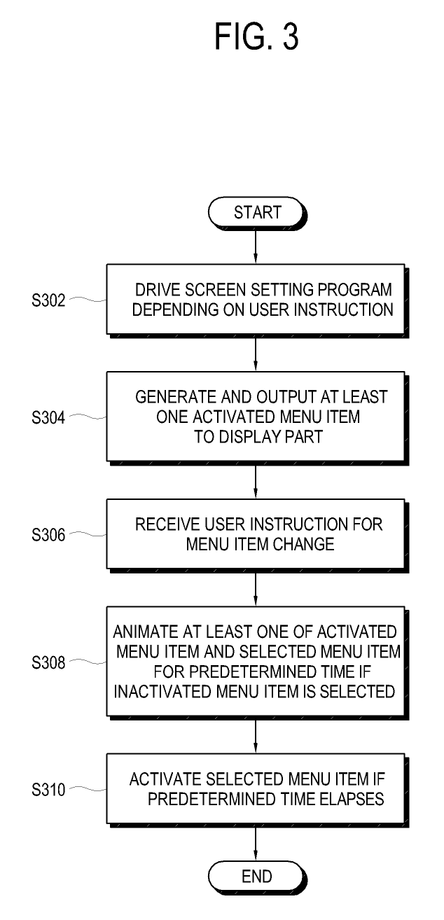

FIG. 3 is a flowchart illustrating a control method of an image processing apparatus according to a first exemplary embodiment of the present invention.

A user drives a screen setting program of a control part 140 through a user inputting part 130 (S302). Depending on the screen setting program of the control part 140, a menu generating part 110 generates a GUI screen 500 having a plurality of menu items including at least one activated menu item, and displays the GUI screen 500 in a display part 120 (S304). Accordingly, the GUI screen 500 as shown in FIG. 5A is displayed in the display part 120.

The control part 140 receives instruction of the user through the user inputting part 130 for a menu item change (S306). If an inactivated menu item is selected from the user inputting part 130, the control part 140 controls the menu generating part 110 so that at least one of an activated menu item and the selected menu item is animated for a predetermined time (S308). For example, if the user selects an inactivated color tab 520 through the user inputting part 130 in the GUI screen 500 shown in FIG. 5A, the menu generating part 110 displays an activated screen tab 510 so that it becomes gradually vaguer, and displays the selected color tab 520 so that it becomes gradually stronger for a predetermined time as shown in FIG. 5B. Also, the menu generating part 110 processes a text property so that a brightness menu 511, a contrast menu 512 and a magic bright 513 of the activated screen tab 510 can gradually disappear.

Then, the control part 140 controls the menu generating part 110 to activate the selected menu item if the predetermined time elapses (S310). The menu generating part 110 finally activates and displays only the color tab 520 in the GUI screen 500, and displays a background color adjusting menu 521, a correcting menu 522, a magic color menu 523, a gamma adjusting menu 524 and a color saturation menu 525 as an adjusting menu of the color tab 520. Also, the menu generating part 110 displays a menu setting information, that is, a gamma value set as a sub menu with respect to the gamma adjusting menu 524.

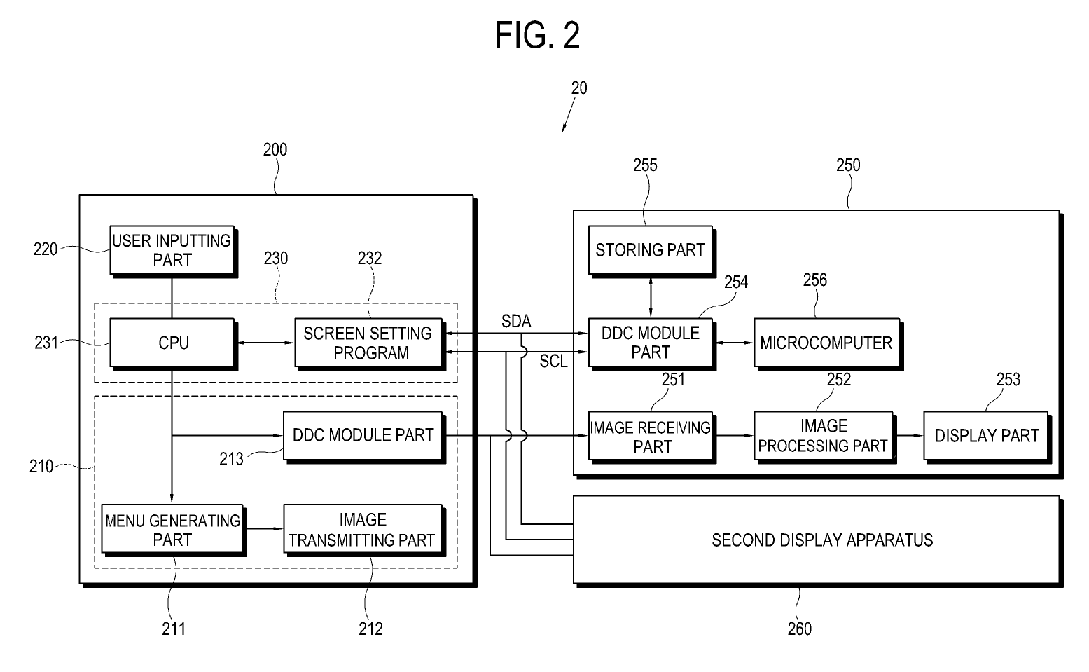

FIG. 2 is a block diagram illustrating a configuration of an image display control apparatus and a display apparatus according to a second exemplary embodiment of the present invention. As shown in FIG. 2, an image display control system 20 includes an image display control apparatus 200 and a display apparatus 250.

The image display control apparatus 200 controls a screen setting state of the display apparatus 250, and includes a computer or a set-top box. As shown in FIG. 2, the image display control apparatus 200 embodied by the computer includes a graphics card 210, a user inputting part 220 and a control part 230. The graphics card 210 includes a menu generating part 211, an image transmitting part 212 and a display data channel (DDC) module part 213 as a communicating module part. The graphics card 210 of an exemplary embodiment of the present invention is an example in which the computer is the image display control apparatus 200; however, the menu generating part 211 may operate in other configurations instead of the graphics card 210.

The control part 230 includes a central processing unit (CPU) 231, and a screen setting program 232 setting a screen of the display apparatus 250. Accordingly, if a user drives the screen setting program 232 through the user inputting part 220, the control part 230 controls the menu generating part 211 and the DDC module part 213 of the graphics card 210.

The display apparatus 250 includes an image receiving part 251, an image processing part 252, a display part 253, a DDC module part 254 as a communicating module part, a storing part 255 and a microcomputer 256. A menu setting information is stored in the storing part 255, and an image signal received by the image receiving part 251 is processed by the image processing part 252 and displayed in the display part 253.

FIG. 2 illustrates a DDC channel including a serial data line (SDA) and a serial clock line (SCL) between the DDC module part 213 of the image display control apparatus 200 and the DDC module part 254 of the display apparatus 250. A D-sub connection type may be used for the DDC channel and for transmitting an image signal from the image transmitting part 212 to the image receiving part 251 shown in FIG. 2. According to the D-sub connection type, fifteen fine, respectively shielded, wires are provided inside a single thick cable, and an image signal is independently transmitted by a respective wire. Accordingly, the D-sub connection type can obtain an image of high quality. Also, while information is exchanged between the display apparatus 250 and the graphics card 210 by means of the DDC channel, optimum resolution and color can be automatically adjusted. However, the DDC module part 213 may be preferably, but is not necessarily, provided in the image display control apparatus 200 for information exchange with the display apparatus 250. Alternatively, other wire or wireless communicating module parts that are capable of exchanging information with the display apparatus 250 may be applied thereto.

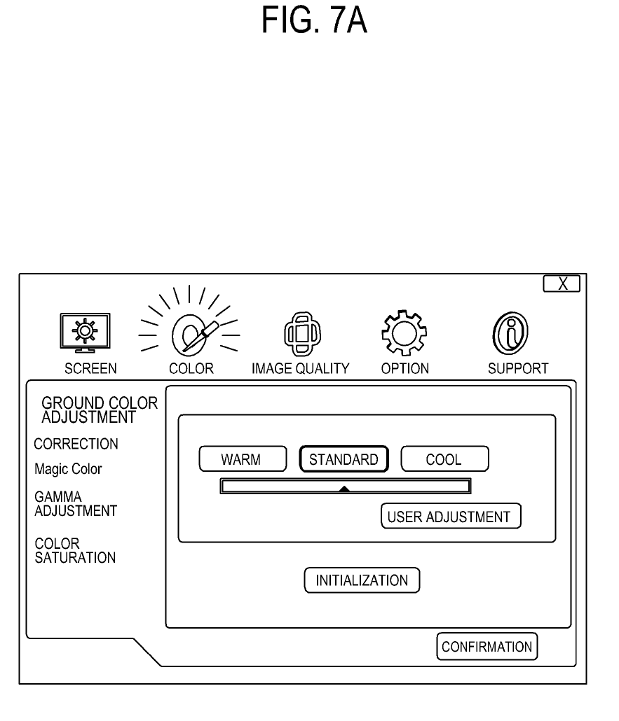

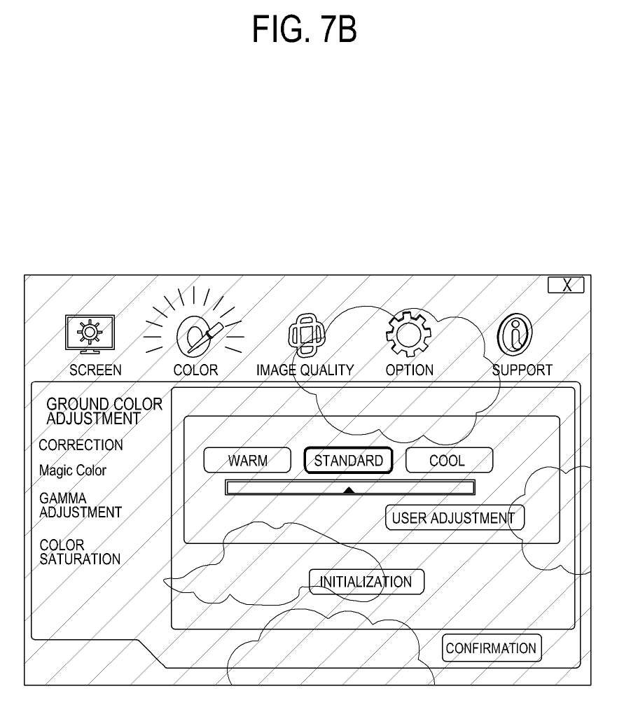

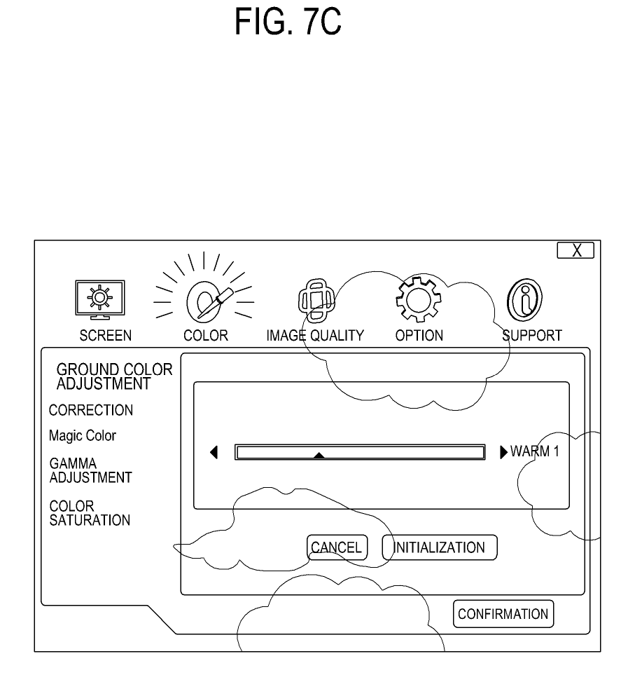

The example of the tab menu change shown in FIGS. 5A to 5C, and the example of the adjusting menu change shown in FIGS. 6A to 6C may also be embodied by the image display control system 20. Also, as shown in FIG. 2, the image display control system 20 may include, in addition to the image display control apparatus 200 and the first display apparatus 250, a second display apparatus 260, which allows the image display control system 20 to operate as a dual display apparatus. FIGS. 7A to 7C illustrate an example of changing of a menu item between the display apparatuses according to the exemplary embodiment of the present invention. A GUI screen 500 shown in FIG. 7A refers to a screen displayed in the second display apparatus 260.

If a user drags the GUI screen 500 displayed in the second display apparatus 260 to the first display apparatus 250 through the user inputting part 220, the control part 230 controls the DDC module part 213 so that a request for a menu setting information about an adjusting menu activated in the dragged GUI screen 500 is communicated to the first display part 250.

As shown in FIG. 7B, the menu generating part 211 displays the GUI screen 500, which has been moved and displayed in the first display apparatus 250 and becomes gradually vaguer (shown by cloudy portions) based on control of the control part 230.

If a new menu setting information to be stored in the storing part 255 of the first display apparatus 250 is received through the DDC module part 213, the control part 230 controls the menu generating part 211 so that the received menu setting information is displayed as a sub menu. As shown in FIG. 7C, the control part 230 may control the menu generating part 211 so that a new GUI screen 500 including a plurality of menu items appropriate for the first display apparatus 250 can be gradually activated.

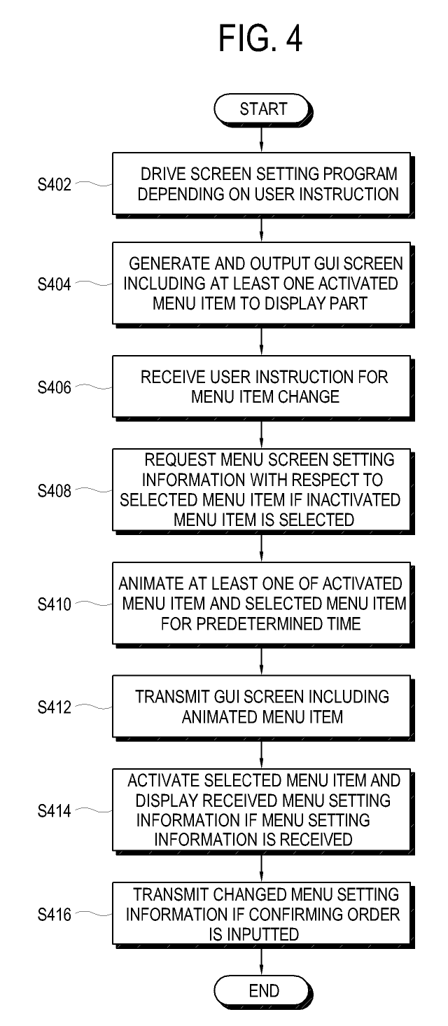

FIG. 4 is a flowchart illustrating a control method of an image display control apparatus 200 according to a second exemplary embodiment of the present invention.

To adjust a screen setting of a display apparatus 250, a user drives a screen setting program 232 through a user inputting part 220 (S402).

The CPU 231 controls the DDC module part 213. The DDC module 213 is a communicating module part that communicates a request for a menu setting information to be displayed that is stored in a storing part 255 of the display apparatus 250 to be activated in the GUI screen 500 based on the screen setting program 232. Accordingly, a data format according to Inter-Integrated Circuit (12C) protocol is transmitted to the display apparatus 250 through the DDC channel. The DDC module part 254, which is a communicating module part of the display apparatus 250, receives the data format through the DDC channel, and transmits the received data format to a microcomputer 256. The microcomputer 256 controls the DDC module part 254 so that the data format is analyzed and a corresponding menu setting information stored in the storing part 255 is transmitted to the image display control apparatus 200. If the CPU 231 receives the menu setting information through the DDC module part 213, the CPU 231 controls a menu generating part 211 so that the GUI screen 500 shown in FIG. 5A is generated and output (S404). Accordingly, the GUI screen 500 shown in FIG. 5A is displayed in a display part 253.

The control part 230 receives instruction of the user through the user inputting part 220 for changing of a menu item (S406).

If the user selects an inactivated color tab 520 through the user inputting part 220, the control part 230 controls the DDC module part 213 so that a request for a menu setting information with respect to the selected color tab 520 is sent to the storing part 255 of the display apparatus 250 (S408).

The control part 230 animates at least one of an activated menu item and the selected menu item for a predetermined time for which the corresponding menu setting information is received through the DDC module part 213 (S410). For example, as shown in FIG. 5B, an activated screen tab 510 is displayed such that it becomes gradually vaguer, and the selected color tab 520 is displayed such that it becomes gradually stronger. Also, the menu generating part 211 processes a text property so that a brightness menu 511, a contrast menu 512 and a magic bright 513 of the activated screen tab 510 can gradually disappear.

The image transmitting part 212 transmits the GUI screen 500 including the animated menu item to the display apparatus 250 (S412). Accordingly, a continuous and dynamic change is displayed between the activated menu item and the selected menu item in the GUI screen 500 of the display part 253.

If the CPU 231 receives the menu setting information through the DDC module part 213, the CPU 231 controls the menu generating part 211 so that the GUI screen 500 shown in FIG. 5C is generated and output (S414). Accordingly, the GUI screen 500 shown in FIG. 5C is displayed in the display part 253.

If the user changes the menu setting information displayed in a sub menu through the user inputting part 220 and clicks a confirming button 560, the control part 230 controls the DDC module part 213 so that the changed menu setting information is transmitted to the display apparatus 250 (S416). The microcomputer 256 of the display apparatus 250 stores the menu setting information received through the DDC module part 254 in the storing part 255.

As described above, the exemplary embodiments of the present invention provide an image processing apparatus, an image display control apparatus and a control method thereof that enables a user to easily and comfortably use an adjusting menu item.

Also, the exemplary embodiments of the present invention provide an image processing apparatus, an image display control apparatus and a control method thereof that continuously and dynamically changes a menu item on a screen unlike a conventional static change.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus, comprising:
a menu generating part which generates and outputs a plurality of menu items which comprise at least one activated menu item;
a user inputting part which receives instruction of a user to select one of the plurality of menu items; and
a control part which controls the menu generating part, if an inactivated menu item is selected from the user inputting part, so that at least one of the activated menu item and the selected menu item is animated for a predetermined time, and the selected menu item is activated after the predetermined time elapses.

2. The image processing apparatus according to claim 1, wherein the menu items comprise a plurality of tab menus which display a high level menu item, and a plurality of adjusting menus which display a low level menu item.

3. The image processing apparatus according to claim 2, wherein, if an inactivated tab menu is selected from the user inputting part, the control part controls the menu generating part so that an image of the activated tab menu becomes gradually vaguer, and an image of the selected tab menu becomes gradually stronger.

4. The image processing apparatus according to claim 2, wherein, if an inactivated tab menu is selected from the user inputting part, the control part controls the menu generating part so that text of an adjusting menu with respect to the activated tab menu gradually disappears.

5. The image processing apparatus according to claim 3, wherein, if an inactivated adjusting menu is selected from the user inputting part, the control part controls the menu generating part so that the size of text of the activated adjusting menu is gradually reduced, and the size of text of the selected adjusting menu is gradually enlarged.

6. The image processing apparatus according to claim 3, wherein, if an inactivated adjusting menu is selected from the user inputting part, the control part controls the menu generating part so that the color of text of the activated adjusting menu is gradually changed into an inactivation mode, and the color of text of the selected adjusting menu is gradually changed into an activation mode.

7. The image processing apparatus according to claim 3, wherein the menu items further comprise a sub menu with respect to the adjusting menu, and
if an inactivated adjusting menu is selected from the user inputting part, the control part controls the menu generating part so that a sub menu with respect to the selected adjusting menu is generated after the animation of the activated adjusting menu and the selected adjusting menu is ended.

8. The image processing apparatus according to claim 3, wherein the menu items further comprise a plurality of sub menus with respect to the adjusting menus, and
if an inactivated sub menu is selected from the user inputting part, the control part controls the menu generating part so that the activated sub menu is gradually changed into an inactivation mode, and the selected sub menu is gradually changed into an activation mode.

9. An image display control apparatus which controls a setting state of a display apparatus, the image display control apparatus comprising:
a menu generating part which generates and outputs a user interface (UI) screen, which comprises a plurality of menu items which comprise at least one activated menu item;
an image transmitting part which transmits the UI screen to the display apparatus;
a communicating module part which transmits and receives a menu setting information of the display apparatus; and
a control part which controls, if an inactivated menu item is selected, the communicating module part so that a request for a menu setting information with respect to the selected menu item is communicated to the display apparatus, and controls the menu generating part so that at least one of the activated menu item and the selected menu item is animated for a predetermined time.

10. The image display control apparatus according to claim 9, further comprising a user inputting part which receives instruction of a user for change of the menu item,
wherein, if an inactivated menu item is selected from the user inputting part, the control part controls the communicating module part so that a request for a menu setting information with respect to the selected menu item is communicated to the display apparatus.

11. The image display control apparatus according to claim 10, wherein the menu items comprise a plurality of tab menus which display a high level menu item, and a plurality of adjusting menus which display a low level menu item.

12. The image display control apparatus according to claim 11, wherein, if an inactivated tab menu is selected from the user inputting part, the control part controls the menu generating part so that an image of the activated tab menu becomes gradually vaguer, and an image of the selected tab menu becomes gradually stronger.

13. The image display control apparatus according to claim 12, wherein, if an inactivated adjusting menu is selected from the user inputting part, the control part controls the menu generating part so that the size of text of the activated adjusting menu is gradually reduced, and the size of text of the selected adjusting menu is gradually enlarged.

14. The image display control apparatus according to claim 12, wherein, if an inactivated adjusting menu is selected from the user inputting part, the control part controls the menu generating part so that the color of text of the activated adjusting menu is gradually changed into an inactivation mode, and the color of text of the selected adjusting menu is gradually changed into an activation mode.

15. The image display control apparatus according to claim 13, wherein the menu items further comprise a sub menu with respect to the adjusting menus, and
if a corresponding menu setting information is received through the communicating module part, the control part controls the menu generating part so that the received menu setting information is generated as a sub menu with respect to the selected adjusting menu.

16. The image display control apparatus according to claim 15, wherein, if a confirming order is inputted from the user inputting part, the control part controls the communicating module part so that a menu setting information displayed in the sub menu is transmitted to the display apparatus.

17. The image display control apparatus according to claim 10, wherein, if a first UI screen displayed in a first display apparatus is moved to a second display apparatus through the user inputting part, the control part controls the menu generating part so that the first UI screen becomes gradually vaguer, and a second UI screen which comprises a plurality of menu items appropriate for the second display apparatus is gradually activated.

18. The image display control apparatus according to claim 17, wherein, if the first UI screen displayed in the first display apparatus is moved to the second display apparatus through the user inputting part, the control part controls the communicating module part so that a request for a menu setting information with respect to the activated adjusting menu is communicated to the second display apparatus.

19. The image display control apparatus according to claim 18, wherein, if a corresponding menu setting information is received from the second display apparatus through the communicating module part, the control part controls the menu generating part so that the received menu setting information is displayed as a sub menu with respect to the activated adjusting menu.

20. A control method of an image processing apparatus which comprises a menu generating part, which generates and outputs a plurality of menu items which comprise at least one activated menu item, the control method comprising:
receiving instruction of a user to select one of the plurality of menu items;
animating at least one of the activated menu item and an inactivated selected menu item for a predetermined time if the inactivated menu item is selected; and
activating the selected menu item if the predetermined time elapses.

21. The control method of the image processing apparatus according to claim 20, wherein the menu items comprise a plurality of tab menus which display a high level menu item, and
if an inactivated tab menu is selected, the animating comprises processing an image of the activated tab menu so that it becomes gradually vaguer, and processing an image of the selected tab menu so that it become gradually stronger.

22. The control method of the image processing apparatus according to claim 21, wherein the menu items comprise a plurality of adjusting menus which display a low level menu item, and
if an inactivated adjusting menu is selected, the animating comprises gradually reducing the size of text of the activated adjusting menu, and gradually enlarging the size of text of the selected adjusting menu.

23. The control method of the image processing apparatus according to claim 21, wherein the menu items comprise a plurality of adjusting menus which display a low level menu item, and
if an inactivated adjusting menu is selected, the animating comprises gradually changing the color of text of the activated adjusting menu into an inactivation mode, and gradually changing the color of text of the selected adjusting menu into an activation mode.

24. The control method of the image processing apparatus according to claim 22, wherein the menu items comprise a plurality of sub menus with respect to the adjusting menu, and
if an inactivated sub menu is selected, the animating comprises gradually changing the activated sub menu into an inactivation mode, and gradually changing the selected sub menu into an activation mode.

25. A control method of an image display control apparatus which controls a setting state of a display apparatus, and comprises a menu generating part which generates and outputs a user interface (UI) screen which comprises a plurality of menu items which comprise at least one activated menu item, the control method comprising:
receiving instruction of a user to select of one of the plurality of menu items;
requesting a menu setting information with respect to a selected inactivated menu item to the display apparatus if the inactivated menu item is selected;
animating at least one of the activated menu item and the selected menu item for a predetermined time; and
transmitting a user interface (UI) screen which comprises the animated menu item to the display apparatus.

26. The control method of the image display control apparatus according to claim 25, further comprising activating the selected menu item, if a corresponding menu setting information is received, and displaying the received menu setting information.

27. The control method of the image display control apparatus according to claim 26, further comprising transmitting a changed menu setting information to the display apparatus if a confirming order is inputted.

28. The control method of the image display control apparatus according to claim 25, further comprising communicating a request for a menu setting information with respect to the activated adjusting menu to a second display apparatus if a first UI screen displayed in a first display apparatus is moved to the second display apparatus.

29. The control method of the image display control apparatus according to claim 28, further comprising making the first UI screen be gradually vaguer, and gradually activating a second UI screen which comprises a plurality of menu items appropriate for the second display apparatus if the first UI screen displayed in the first display apparatus is moved to the second display apparatus.

30. The control method of the image display control apparatus according to claim 29, further comprising displaying a received corresponding menu setting information if the corresponding menu setting information is received from the second display apparatus.
